(19) United States
(12) Patent Application Publication
(10) Pub. No.: US 2009/0121956 A1
(43) Pub. Date: May 14, 2009

(54) ANTENNA DEVICE

(75) Inventors: Fukuro Koshiji, Tokyo (JP); Toshiya Eguchi, Tokyo (JP)

Correspondence Address: CANTOR COLBURN, LLP, 20 Church Street, 22nd Floor, Hartford, CT, 06103, US

(73) Assignee: KONICA MINOLTA HOLDINGS, INC., Tokyo, (JP)

(21) Appl. No.: 12/091,881

(22) PCT Filed: Sep. 27, 2006
(86) PCT No.: PCT/JP2006/319104

§ 371 Date: Apr. 28, 2008

(30) Foreign Application Priority Data
Nov. 1, 2005 (JP) JP2005-318357

(51) Int. Cl. H01Q 1/36; H01Q 1/48; H01Q 21/00

(52) U.S. Cl. 343/794; 343/908; 343/845

(57) ABSTRACT

Disclosed is an antenna device capable of reducing an input impedance and having a wideband characteristic. The antenna device includes: a first radiating plate of a flat shape; a second radiating plate of a flat shape; and an electric feeding section electrically connected to the first radiating plate and the second radiating plate, wherein the first radiating plate and the second radiating plate have different shapes in a plan view and are combined and provided, and both end corner portions of a side portion to which the electric feeding section is connected, of the first radiating plate, are formed in an arc shape.

### TECHNICAL FIELD

The present invention relates to an antenna device, particularly relates to an antenna device having a plurality of radiating plates.

### BACKGROUND

With regard to the antenna device having a plurality of radiating plates, a monopole type antenna device, in which at least one of radiating plates is grounded and used as a ground plate, and a dipole type antenna device having the same two radiating plates are known.

As an example of the monopole type antenna device, as illustrated in FIG. 14, there is an antenna device 52 having a first radiating plate 50 of a trapezoidal shape in a plan view and a second radiating plate 51 of a rectangular shape larger than the first radiating plate 50. The first radiating plate 50 and the second radiating plate 51 are formed of a conductive material, and the second radiating plate 51 is grounded by the well-known earthing device 53, and functions as a ground plate.

An upper side of the first radiating plate 50, and a long side of the second radiating plate 51 are disposed in substantially parallel with a gap of width “g”, and electric power is fed through an electric feeding section 54 from the gap side. Here, as for the first radiating plate 50, the upper side is set to 12 mm, the lower side is set to 32.5 mm and the height is set to 15 mm. As for the second radiating plate 51 is formed so that the long side may be set to 40 mm and a short side may be set to 20 mm.

According to such a monopole type antenna device 52, when electric power is fed to the first radiating plate 50 from the electric feeding section 54, as illustrated by arrow marks in FIG. 14, electric current will flow along the both-sides edge of the first radiating plate 50 from the electric feeding section 54. Then, since the mirror image (a dotted line in FIG. 14), of the first radiating plate 50 is formed on the second radiating plate 51, radiowave is transmitted and received from both the first radiating plate 50 and the second radiating plate 51.

As an example of a dipole type antenna device, as illustrated in FIG. 15, there is an antenna device 56 having two radiating plates 55 and 55 of a trapezoidal shape in a plan view. The upper sides of the radiating plates 55 are arranged so that the gap of predetermined width is provided and the upper sides may become substantially in parallel. In addition, an electric feeding section 57, which feeds electric power to each radiating plate 55, is connected to a center of the upper side of the each radiating plates 55. Here, with regard to radiating plates 55, the upper side is set to 15 mm, the lower side is set to 32.5 mm and the height is set to 15.16 mm.

According to such dipole type antenna device 56, by feeding electric power to each radiating plate 55 from the electric feeding section 57, as illustrated by the arrow mark in FIG. 15, electric current flows along the sides of each radiating plate 55, and radiowave is transmitted and received. And it is known that antenna characteristics of bandwidth can be widened by making the shape of the radiating plates 55 into a self-similar figure.

In addition, as disclosed in a patent reference No. 1, an antenna device having a wideband characteristic having a high degree of freedom for shaping of the radiating plates has been developed. According to such antenna device, the electric feeding section is provided on the predetermined position in the gap between radiating plates, the electric current fed from the electric feeding section is transmitted in the direction by which a self-similar figure tends to be formed, and a wideband characteristic is arranged to be acquired.

Patent reference No. 1: Disclosure in Unexamined Japanese Patent Application Publication No. 2005-117363 Official Report

### DISCLOSURE OF INVENTION

### Problems to be Solved by the Present Invention

However, in the conventional antenna device, there was a problem that reduction of input impedance was difficult and the input impedance became high, about 200-300 ohms. Therefore, in cases where electric power was fed directly to the antenna by a 50-ohm transmission line system of the commonly used microwave circuit, due to the impedance miss matching, the fed electric power was reflected greatly. As a result, there was a problem that radiowave could not be transmitted and received effectively. Furthermore, in cases where the 50Ω transmission line system was connected to the antenna through an unbalanced-balanced conversion circuit and an impedance conversion circuit, there was also a problem that the antenna device itself will be enlarged.

The present invention is made in view of such a point, and an object of the present invention is to provide an antenna device being capable of reducing input impedance and having a wideband characteristic.

### Means to Solve the Problems

In order to solve the above-mentioned subject, the invention of claim 1 is as following. An antenna device comprises a plurality of radiating plates having a flat plate shape, and an electric feeding section electrically connected to each radiating plate of the plurality of radiating plates, wherein the plurality of radiating plates is formed by combining plates having different shapes in a plan view, and at least one radiating plate among the plurality of radiating plates is configured that both end corner portions of the side portion to which the electric feeding section is connected are formed in an arc shape.

According to the invention of claim 1, a plurality of radiating plates having different shapes is combined and the paths into which the electric current along the edge of radiating plates flows respectively, differ. Since the path, into which electric current flows, determines the resonance frequency of the antenna device, in case when the shapes of the radiating plates in a plan view differ, resonance frequency will also differ.

In addition, since both end corner portions of the side portion to which an electric feeding section is connected are formed in the arc shape, the electric current from an electric feeding section easily flows along both end corner portions of the side portion of the radiating plates, and as a result, the input impedance decreases.

The invention of claim 2 is as following. The antenna device according to claim 1, wherein the radiating plate which is configured that both end portions of the side portion to which the electric feeding section is connected are formed in the arc shape, has a semicircular shape in a plan view.

According to invention of claim 2, since the radiating plate which is configured that both end portions of the side portion to which an electric feeding section is connected are formed in the arc shape in plan view, has a semicircular shape in a plan view, electric current is easy to flow from an electric feeding section in an arc along the both side ends of radiating plate, and input impedance decreases.

The invention of claim 3 is as following. The antenna device according to claim 2, wherein two plates of the radiating plates are provided and an other radiating plate has a trapezoidal shape in a plan view.

According to the invention of claim 3, since the radiating plate having a semicircular shape in a plan view and the radiating plates having a trapezoidal shape in a plan view are combined, the antenna device is structured by the radiating plate in which the electric current from the electric feeding section can flow into the arc shape along the both-sides edge of the radiating plate, and the radiating plate wherein the side section of the radiating plate, to which the electric feeding section is connected is a straight line.

Therefore, it becomes possible to adjust the input impedance flexibly, while reducing the input impedance of antenna device.

The invention of claim 4 is as following. The antenna device according to any one of claims 1-3, wherein at least one of the radiating plates is grounded.

According to the invention given in the scope of claim 4, since at least one of radiating plates is grounded, when electric current flows into radiating plates, it will function as a ground plate, which forms the mirror image of the current flow.

### EFFECTS OF THE INVENTION

According to the invention of claim 1, since resonance frequency changes with radiating plates, it is possible to increase the number of resonance points and to widen the bandwidth rather than using a plurality of radiating plates of identical shape. In addition, since the radiating plates which are configured that the both end portions of the side portion to which an electric feeding section is connected are formed into an arc shape are used, it is possible to reduce the input impedance. Therefore, the antenna device having low input impedance and a wideband characteristic can be provided.

According to the invention of claim 2, the input impedance can be reduced effectively.

According to the invention of claim 3, since the radiating plate, in which the electric current from an electric feeding section easily flows along the both side end portions of radiating plate in an arc shape, is used, it is possible to reduce the input impedance of antenna device. In addition, since the side portion to which an electric feeding section is connected uses the radiating plates having a straight line, the adjustment of the input impedance can be easily and flexibly conducted by adjusting the length of the side portion. Thus, it becomes possible to reduce the input impedance of the antenna device and at the same time, the adjustment of the input impedance can be easily conducted.

According to the invention of claim 4, since at least one of radiating plates functions as a ground plate, it is also applicable to a monopole type antenna device.

### BRIEF DESCRIPTION OF THE DRAWINGS

FIG. 1 illustrates a plan view of the antenna device of a first embodiment.

FIG. 2 illustrates a diagram showing that both end corner portions of the side portion of the radiating plate is formed in an arc shape.

FIG. 3 illustrates a graph showing VSWR characteristic curves of the antenna device of the first embodiment, and the conventional antenna device.

FIG. 4 illustrates a graph showing the input resistance and the input reactance of the antenna device of the first embodiment, and the conventional antenna device.

FIG. 5 illustrates a graph showing the VSWR characteristics for different widths of the gap in the antenna device of the first embodiment.

FIG. 6 illustrates a graph showing the change of input resistance and input reactance for different widths of the gap in the antenna device of the first embodiment.

FIG. 7 illustrates a plan view showing the antenna device of the second embodiment.

FIG. 8 illustrates a graph showing VSWR characteristic curves of the antenna device of the second embodiment and the conventional antenna device, and showing VSWR characteristics for different widths of the gap in the antenna device of the second embodiment.

FIG. 9 illustrates a graph showing the change of input resistance and input reactance for different widths of the gap in the antenna device of the second embodiment.

FIG. 10 illustrates a plan view of the antenna device of the third embodiment.

FIG. 11 illustrates VSWR characteristic curves of an antenna device of the third embodiment having semicircular and trapezoidal dipole, a conventional balanced trapezoidal dipole antenna device and a conventional unbalanced trapezoidal dipole antenna device.

FIG. 12 illustrates a plan view of the modification of the antenna device of the third embodiment.

FIG. 13 illustrates a plan view of the modification of the antenna device of the third embodiment.

FIG. 14 illustrates a plan view of the conventional monopole type antenna device.

FIG. 15 illustrates a plan view of the conventional dipole type antenna device.

### EXPLANATION OF SYMBOLS

1, 10, and 12: Antenna device
2, 11, and 14: First radiating plate,
3 and 13: Second radiating plate
4: Support plate
5: Electric feeding section
6: Earthing device

### PREFERRED EMBODIMENT OF THE INVENTION

Hereinafter, embodiments of the antenna device related to the present invention will be described by referring to drawings. However, the scope of the invention is not limited to the examples of the illustrations.

### First Embodiment

An antenna device 1 of this embodiment is a monopole type antenna device 1 having a first radiating plate 2 of a substantially trapezoidal shape in a plan view, and a second radiating plate 3 grounded having a substantially rectangular shape in a plan view.

Firstly, the structure of the antenna device 1 will be described.

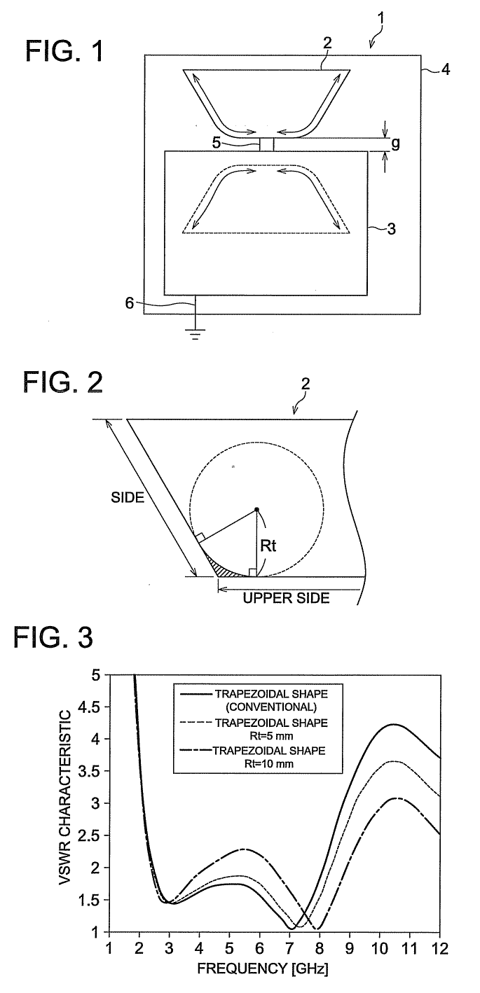

As illustrated in FIG. 1, the antenna device 1 is equipped with a supporting base 4 having a plate shape, which supports the first radiating plate 2 and the second radiating plate 3. The supporting base 4 is formed from dielectric materials, such as Teflon (registered trademark). In addition, the supporting base 4 may form a circuit board of the electric device or a signal processing device (all are not shown), which processes the electric signals from the antenna device 1 by using predetermined number of circuit boards in piles.

As a material of the first radiating plate 2 and the second radiating plate 3, conductive materials, such as aluminum and copper, can be applied and gold-plating treatment for rust prevention is applied to the upper surface of the copper foil in this embodiment. The first radiating plate 2 and the second radiating plate 3 are arranged onto one surface of the supporting base 4 so that the upper side of the first radiating plate 2 and the long side of the second radiating plate 3 may provide the gap of width “g” and may become substantially in parallel to each other. The input impedance of the antenna device 1 decreases, as the width “g” of the gap becomes narrower. In addition, in FIG. 1, the first radiating plate 2 and the second radiating plate 3 are arranged to be extended over one face of the supporting base 4. However, since mounting is difficult in cases where the width “g” of the gap is not more than 0.5 mm, the first radiating plate 2 and the second radiating plate 3 may be respectively mounted on both faces of the supporting base 4.

The both end corner portions of the upper side portion of the first radiating plate 2 are formed in an arc shape. Here, as illustrated in FIG. 2, “forming in an arc shape” denotes that a circle which contacts the upper side and the side of the first radiating plate 2 is arranged, and an arc shape is to be formed along an arc of the circle of the both-end corner portions of the upper side of the first radiating plate 2. Concretely, the portion of hatching illustrated in FIG. 2 is specifically cut away, and the both end corner portions of the upper side are formed into a round shape. It is illustrated that the roundness of the both end corner portions of the upper side of the first radiating plate 2 becomes larger as the radius Rₜ of the circle in contact with the first radiating plate 2 becomes larger. In addition, although the arc shape is formed in an arc shape using a circle, using an ellipse may form the arc shape.

As for the outline dimension of the first radiating plate 2, it is desirable that the upper side is a range of 8-15 mm, the lower side is a range of 10-45 mm, and the height is a range of 12-22 mm. In this embodiment, the upper side is set to 12 mm, the lower side is set to 32.5 mm and the height is set to 15 mm. Here, the length of the upper side or the length of the side denotes a length of the trapezoid upper side or a length of the trapezoid side before rounding.

A well-known earthing device 6 grounds the second radiating plate 3, and when electric current flows into the first radiating plate 2, it will function as a ground plate, which forms the mirror image. As for the size of the second radiating plate 3, it is desirable that the long side is not less than the lower side of the first radiating plate 2 and the short side is not less than the height of the first radiating plate 2. In this embodiment, the long side is set to 40 mm and short side is set to 20 mm.

The gap between the first radiating plate 2 and the second radiating plate 3 is equipped with the electric feeding section 5, which is electrically connected to each of them and transmits voltage and current. As for the installation point of the electric feeding section 5, near the center position in the longitudinal direction of the first radiating plate 2 and the second radiating plate 3 is desirable. In detail, the installation point may be provided within limits which is shifted from the center position to the right and the left by only the width corresponding to 5% of the upper side of the first radiating plate 2 or the long side of the second radiating plate 3.

One end of the transmission line, which is not illustrated, is connected to the electric feeding section 5, and the signal-processing device, which process the electric signal from the antenna device 1, is connected to the other end of the transmission line. Since one surface of the supporting base 4 is equipped with the first radiating plate 2 and the second radiating plate 3, the transmission line provided on the other surface of the supporting base 4 is arranged to be pass through the supporting base 4 by using the electric feeding section 5 equipped with a passing device such as a via hole. In addition, in case where the first radiating plate 2 and the second radiating plate 3 are respectively provided on both sides of the supporting base 4, electric connection is possible without passing the transmission line through the supporting base 4.

Here, there is no restriction in particular for the shape in a plan view of the first radiating plate 2, and both end corner portions of the side portion to which the electric feeding section 5 is connected, should just be formed in the arc shape. Therefore, the portion other than the both end corner portions the side portion to which the electric feeding section 5 is connected, may be any one of a straight line, curves and the combination of those lines. In addition, in cases where the side section to which the electric feeding section 5 is connected is formed by a curve, the curve which constitutes a convex, which is extended towards the electric feeding section 5 is preferable, and it is preferable that the electric feeding section 5 is provided on the vicinity of the vertex.

In addition, in order to equalize the radiating pattern of radiowave, the shape of the first radiating plate 2 in a plan view is preferably a shape symmetrical with regard to a reference axis, which is the perpendicular bisector of the straight line connecting the both ends of the side section to which the electric feeding section 5 is connected.

In addition, with regard to the shape of the second radiating plate 3 in a plan view, there is no restriction in particular, and what is necessary is just a larger shape than the first radiating plate 2 so that the mirror image of the first radiating plate 2 is formed thereon.

Next, transmission and reception of the radiowave by the antenna device 1 related to this embodiment will be described hereinafter.

In cases where the antenna device 1 transmits radiowave, based on the electric signal from an electric device, electric current is fed to the electric feeding section 5 with predetermined amplitude and phase through a transmission line. The electric current fed to the electric feeding section 5 enters into the first radiating plate 2, and as illustrated by an arrow mark in FIG. 1, the electric current flows from the upper side of the first radiating plate 2 to the lower side along both-sides. When electric current flows into the first radiating plate 2, the mirror image (a doted line in FIG. 1) of the first radiating plate 2 will be formed on the second radiating plate 3. Thus, when electric current flows into the first radiating plate 2 and the second radiating plate 3, radiowave will be transmitted from the first radiating plate 2 and the second radiating plate 3.

In case where the antenna device 1 receives radiowave, when the radiowave of a predetermined frequency is received by the first radiating plate 2, the voltage current of the amplitude and the phase according to the received radiowave will flow from the lower side of the first radiating plate 2 toward the electric feeding section 5 of the upper side to along side of the first radiating plate 2. Under the present circumstances, the mirror image of the first radiating plate 2 is formed on the second radiating plate 3, and electric current flows therein. And the electric current, which entered into the electric feeding section 5 is transmitted to signal-processing device through a transmission line, and is processed as electric signals.

Here, VSWR (Voltage Standing Wave Ratio) characteristics of the antenna device 1 will be described.

A VSWR characteristic indicates the wideband characteristic of an antenna device. Generally the range of VSWR value ≦2 is a frequency band, which can be used in a good condition.

The data plotted in FIG. 3 shows measurements results of the VSWR characteristic of the monopole type antenna device 52 using the trapezoidal first radiating plate 50 to which a rounding process has not been applied and the antenna device 1 of this embodiment. The VSWR characteristic curve of the antenna device 1 of this embodiment is going down in a 8 GHz or higher frequency range, and the frequency range is widened, as Rₜ is enlarged so that the side portion of both ends corner portions of the first radiating plate 2 is made into a big arc shape. On the other hand, the VSWR characteristic near 5-6 GHz rises as the Rₜ becomes large, but the VSWR value is held not more than 2.5.

In addition, input impedance of the antenna device 1 will be described.

Here, the input impedance is expressed with the sum of input resistance and input reactance. Input resistance is a value calculated by dividing the amount of voltage vectors in the electric feeding section 5 by the amount of current vectors. Input reactance is a value calculated by the reflected amount of the electric current, which entered into the electric feeding section 5.

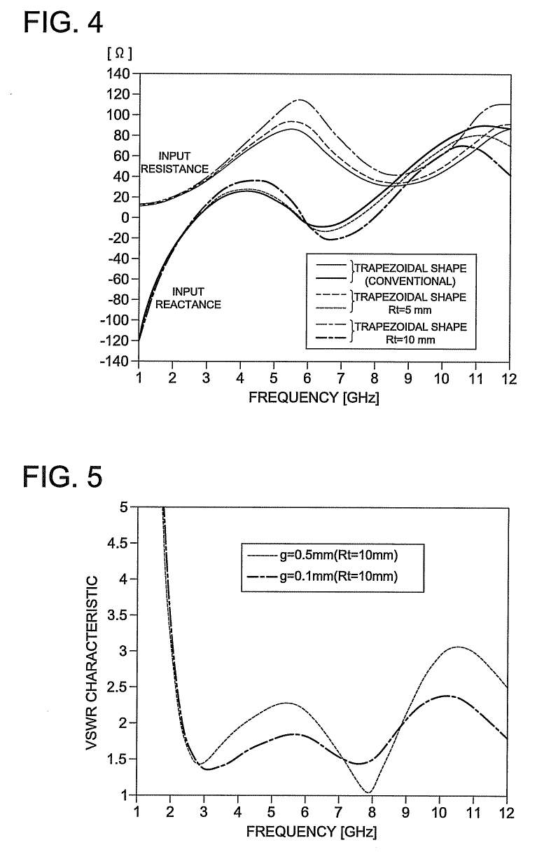

The data indicated in FIG. 4 is a measurement result of the input resistance and the input reactance of the monopole type antenna device 52 using the conventional first radiating plate 50 and the antenna device 1 of this embodiment. By forming the both end corner portions of the upper side in an arc shape like the first radiating plate 2 of this embodiment, input reactance decreases in the range of not less than 6 GHz. In addition, the amount of decrease of input reactance becomes larger as the Rₜ is enlarged, and the input reactance decreases remarkably particularly in the range not less than 10 GHz.

From the above result, the VSWR characteristic in a high frequency band decreases, and broadening the bandwidth of the antenna device 1 of this embodiment. In addition, the input impedance decreases corresponding to the degree of decreasing of the input reactance. This is considered that since the both end corner portions of the upper side of the first radiating plate 2 are formed in an arc shape and electric current flows into the arc shape, the induction element in the first radiating plate 2 decreases and at the same time, electric current becomes to easily flow from the upper side to the side sections of the first radiating plate 2.

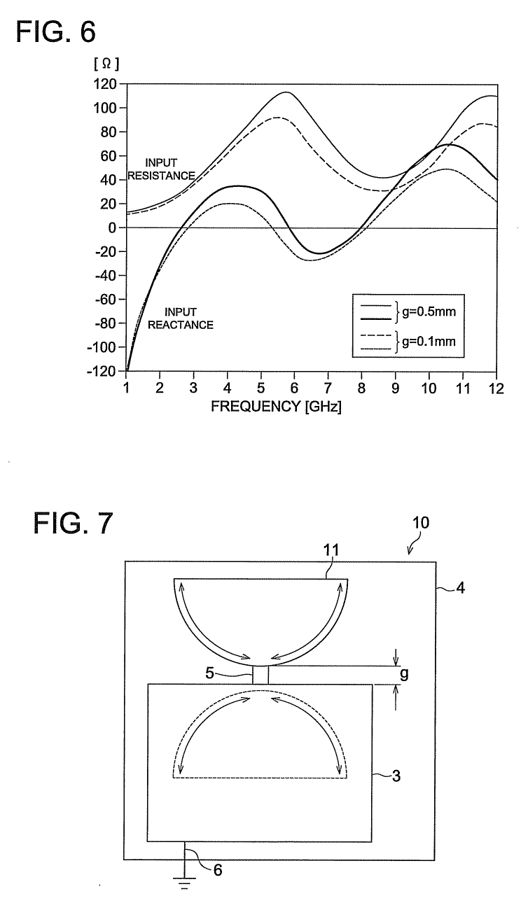

Here, in order to reduce input impedance more, the width “g” of the gap of the first radiating plate 2 and the second radiating plate 3 was changed, and the VSWR characteristic, input resistance and input reactance were measured. As shown in FIGS. 5 and 6, by making width “g” of the gap small, a VSWR characteristic, input resistance, and input reactance are reduced. Here, g=0 mm of the width “g” of the gap denotes that the width “g” of the gap substantially equals to zero. Since, however both sides of the supporting base 4 are respectively equipped with the first radiating plate 2 and the second radiating plate 3, the first radiating plate 2 and the second radiating plate 3, g=0 mm shows a status in which the first radiating plate 2 and the second radiating plate 3 are not electrically in contact.

As mentioned above, in the antenna device 1 of this embodiment, by making width “g” of the gap small, the antenna device 1 shows a wider band characteristic and shows a low input impedance. It is desirable that the both end corner portions of the upper side of the first radiating plate 2 shall be formed in an arc shape having Rₜ=10 mm, and the width “g” of the gap shall be 0.1 mm or less particularly.

### Second Embodiment

Next, the antenna device 10 related to a second embodiment will be explained. The antenna device 10 in this embodiment differs in the shape of a first radiating plate 11 from the first embodiment, and the other structures of the antenna device 10 are the same as that of the first embodiment.

Firstly, the structure of the antenna device 10 will be described.

As shown in FIG. 7, a first radiating plate 11 having a semicircular shape in a plan view is provided on the one surface of the supporting base 4 on the antenna device 10 of this embodiment. It is preferable that the radius of the first radiating plate 11 is in the range of 8-15 mm, and the radius of this embodiment is set to 15 mm. The side portion of the first radiating plate 11 is formed by a circular arc portion, in which both end corner portions of the side portion of were formed in the arc shape, and the straight-line section, which corresponds to a diameter of the circle.

The second radiating plate 3, which is the same as the first embodiment, is provided on a side of the circular arc portion of the first radiating plate 11 with the gap width “g”, and the second radiating plate 3 is grounded by the earthing device 6. The long side of the second radiating plate 3 and the straight line portion of the first radiating plate 11 are arranged in substantially parallel and the circle vertex of the first radiating plate 11 and the center of the second radiating plate 3 are arranged to oppose each other.

Between the circle vertex of the first radiating plate 11 and the center of the long side of the second radiating plate 3, the electric feeding section 5, which is the same as the first embodiment, is provided. One end of the transmission line, which is not illustrated, is connected to the electric feeding section 5, and the signal-processing device, which processes the electric signals from the antenna device 10, is connected to the other end of the line. Here, the installation point of the electric feeding section 5 should just be the vicinity of the circle vertex of the first radiating plate 11, and near the center of the long side of the second radiating plate 3. In detail, the installation point may be provided within limit which is shifted from the center position to the right and the left by only the width corresponding to 5% of the diameter of the first radiating plate 11 and which is shifted from the center position to the right and the left by only the width corresponding to 5% of the long side of the second radiating plate 3.

The transmitting and receiving method of the radiowave of such antenna device 10 is the same as that of the first embodiment. In case when, electric current flows into the first radiating plate 11, at the same time, the mirror image (dotted line in FIG. 7) of the first radiating plate 11 is formed on the second radiating plate 3 and radiowave is transmitted and received.

Next, the VSWR characteristic of the antenna device 10, and the measurement results of input impedance will be described.

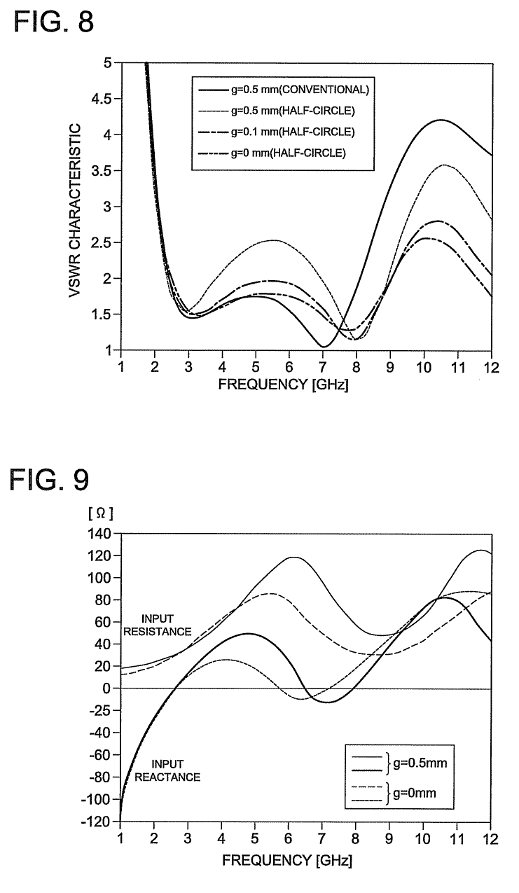

As shown in FIG. 8, compared with the monopole type antenna device 52, which used the conventional first radiating plate 50, the VSWR characteristic of the antenna device 10 of this embodiment remarkably becomes low in a not less than 8 GHz high frequency band. By setting the width “g” of the gap between the first radiating plate 11 and the second radiating plate 3 to not more than 0.1 mm, the VSWR value will be controlled not more than 2 in the frequency range of 5-6 GHz.

As shown in FIG. 9, the value of input resistance decreases, as the width “g” of the gap between the first radiating plate 11 and the second radiating plate 3 becomes smaller in the antenna device 10 of this embodiment. The input reactance in the frequency range of 5 to 6 GHz also decreases.

As mentioned above, according to the antenna device 10 of this embodiment, by using the semicircular shape first radiating plate 11, the VSWR characteristic in a high frequency band decreases, and indicates a wideband characteristic. In addition, since input reactance decreases in the frequency range of 5-6 GHz while input resistance decreases generally by making width “g” of the gap small, it is possible to reduce the input impedance of the antenna device 10.

### Third Embodiment

Next, the antenna device 12 related to the third embodiment will be described. The antenna device 12 of this embodiment is a dipole type antenna device 12 equipped with a first radiating plate 11 having a semicircular shape in a plan view and the second radiating plate 13 of a trapezoidal shape in a plan view.

Firstly, the structure of the antenna device 12 will be described.

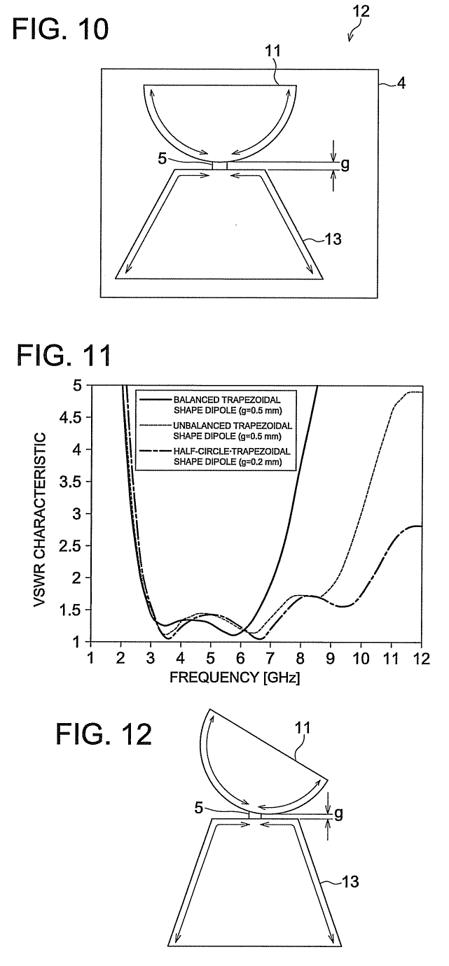

As shown in FIG. 10, the antenna device 12 of this embodiment is equipped with the supporting base 4, which supports the first radiating plate 11 and the second radiating plate 13. One surface of the supporting base 4 is equipped with the same first radiating plate 11 as the second embodiment. On the circular arc portion side of the first radiating plate 11, the second radiating plate 13 of the trapezoidal shape in a plan view is arranged so that the upper side faces to the first radiating plate 11 side. The straight line portion of the first radiating plate 11 and the upper side and the lower side of the second radiating plate 13 are arranged substantially in parallel respectively, and the gap of width “g” is provided between the first radiating plate 11 and the second radiating plate 13.

The same as the first embodiment, gold plating is applied to the upper surface of copper foil and the first radiating plate 11 and the second radiating plate 13 are formed. The first radiating plate 11 is formed so the radius is set to 12.44 mm in outline dimension. It is preferable that the upper side is set to the range of 8-15 mm, the lower side is set to the range of 10-45 mm and the height is set to the range of 12-22 mm. From the viewpoint of combination with the first radiating plate 11, the upper side is set to 15 mm, the lower side is set to 35.55 mm and height has become 17.79 mm.

Between the circle vertex of the first radiating plate 11, and the center of the upper side of the second radiating plate 13, the electric feeding section 5, which feeds electric power to the first radiating plate 11 and the second radiating plate 13, is provided. One end of the transmission line, which is not illustrated, is connected to the electric feeding section 5 like the first embodiment, and the signal-processing device, which process the electric signals from the antenna device 12 is connected to the other end of the transmission line. In addition, the installation point of the electric feeding section 5 is preferably provided near the center portion in the longitudinal direction of the first radiating plate 11 and the second radiating plate 13. In addition, “near the center portion” denotes the range, which is within the limit which is shifted from the center position to the right and the left respectively only by the width corresponding 5% of the diameter of the first radiating plate 11 and the upper side of the second radiating plate 13.

Transmission and reception of the radiowave by such an antenna device 12 is conducted based on a principle substantially the same as the first embodiment. However, in this embodiment, as illustrated by the arrow mark in FIG. 10, the electric current fed from the electric feeding section 5 flows along the arc portion of the first radiating plate 11, and flows along the side from an upper side of the second radiating plate 13. When electric current flows into the first radiating plate 11 or the second radiating plate 13, it will resonate on a predetermined frequency, and radiowave will be transmitted and received.

Next, the VSWR characteristic and input impedance of the antenna device 12 will be described.

As shown in FIG. 11, comparing with a balanced trapezoidal dipole antenna 56 having two radiating plates 55, the VSWR characteristic of the antenna device 12 of this embodiment in the high frequency band of not less than 7 GHz remarkably decreases.

Here, generally the frequency at which radiating plates resonate is determined in the path into which electric current flows. Therefore, in the case of the unbalance type antenna device using several radiating plates having different shapes in a plan view, since the paths, into which the electric current along the edge of radiating plates flows, respectively differ, the resonance frequencies will also differ for each radiating plate. Therefore, comparing with a case where using plural radiating plates of identical shape, the number of resonance points increases and the bandwidth can be widened.

As shown in FIG. 11, in the case of the antenna device of an unbalance trapezoidal dipole in which one of radiating plates 55 of the antenna device 56 is replaced by the radiating plate having a upper side being set to 10.5 mm, lower side being set to 24.88 and the height being set to 12.4 mm, compared with the antenna device 56 of a balanced trapezoidal dipole, the number of resonance points increases and the bandwidth is widened.

In case where the antenna device 12 of the semicircular and trapezoidal dipole related to this embodiment is used, compared with the antenna device of a balanced trapezoidal dipole, a VSWR characteristic decreases and the bandwidth is widened in high frequency band which is not less than 9 GHz. In detail, the first resonance point determined based on the length from the straight line portion of the first radiating plate 11 to the lower side of the second radiating plate 13, the second resonance point determined based on the distance from the electric feeding section 5 to the lower side of the second radiating plate 13, and the third resonance point determined based on the distance from the electric feeding section 5 to the straight line portion of the first radiating plate 11, appear one after the other from where a frequency is lower. Therefore, when the shapes of the first radiating plate 11 and the second radiating plate 13 differ, in addition to the increase of the number of resonance points, by making the first radiating plate 11 into the shape of a semicircle, the third resonance point appears in the range where a frequency is high, and as a result, the bandwidth can be widened.

As mentioned above, according to the antenna device 12 of this embodiment, by using the semicircular shape first radiating plate 11 and the second radiating plate 13 of trapezoidal shape, the VSWR characteristic in a high frequency band can be lowered and a wideband characteristic can be obtained. In addition, since the VSWR value is 2 or less in an about 3-11 GHz frequency band, it can be used as UWB (Ultra Wide Band).

In addition in this embodiment, the straight line section of the first radiating plate 11, and the upper side and the lower side of the second radiating plate 13 are arranged in parallel. However, as shown in FIG. 12, it is also possible to be leaning the straight line section of the first radiating plate 11. In this case, since the paths, into which the electric current along the circle section of the first radiating plate 11 from the electric feeding section 5 flows, differ in the right and the left as an arrow indicates in FIG. 12, it is possible to increase the number of resonance points, and also to make the bandwidth characteristics of the antenna wide.

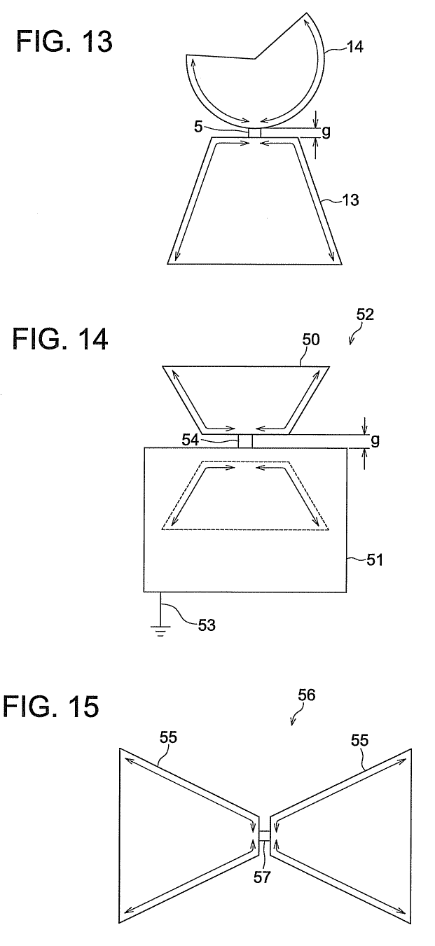

In addition, the shape of the first radiating plate 11 is not limited in the shape of a semicircle, but the edge should just be formed by a circular arc section and a straight-line section. For example, as shown in FIG. 13, a sector-shaped first radiating plate 14 in a plane view will be applicable. In this case, since the paths, into which the electric current along the circular arc section of the first radiating plate 14 from the electric feeding section 5 flows, differ by the right and the left as illustrated by the arrow in FIG. 13, it is possible to increase the number of resonance points, and also to make the bandwidth characteristics of the antenna wide.

1. An antenna device comprising:
a plurality of flat radiating plates; and
an electric feeding section electrically connected to each of the plurality of radiating plates,
wherein the radiating plates comprise combined different shapes of radiating plates in a plan view, and both end corner portions of a side portion to which the electric feeding section is connected, of at least one of the radiating plates, are formed in an arc shape.

2. The antenna device of claim 1, wherein the radiating plate having the side portion to which the electric feeding section is connected, of which both end corner portions are formed in the arc shape, has a semicircular shape in a plan view.

3. The antenna device of claim 2, wherein two pieces of the radiating plates are provided and an other radiating plate has a trapezoidal shape in a plan view.

4. The antenna device according to claim 1, wherein at least one of the radiating plates is grounded.

5. The antenna device according to claim 3, wherein at least one of the radiating plates is grounded.

6. The antenna device according to claim 3, wherein at least one of the radiating plates is grounded.
